(19) United States
(12) Patent Application Publication
(10) Pub. No.: US 2006/0233923 A1
(43) Pub. Date: Oct. 19, 2006

(54) Packaged pet snack dough and method of making same

(76) Inventor: Lori Campbell, Louisville, CO (US)

Correspondence Address: John E. Reilly, 1554 Emerson Street, Denver, CO, 80218, US

(21) Appl. No.: 11/109,246

(22) Filed: Apr. 18, 2005

(51) Int. Cl. A21D 10/02

(52) U.S. Cl. 426/128

(57) ABSTRACT

A commercially packaged, unleavened, uncooked dough product for pets that consists of a texturizing constituent, a protein-based constituent, a fiber-based constituent, a fat-based constituent and a liquid constituent. The pet treat is formed by blending constituents, adding a liquid, packaging and storing the product prior to baking.

### BACKGROUND AND FIELD OF INVENTION

The present invention relates to pet snacks and more specifically to a novel and improved commercially packaged, unleavened pet treat dough and method of making and storing same.

Pet treats are an integral part of our society's love for our pets, as attested by a proliferation of dog and cat bakeries, as well as an ever-increasing number of companies that focus on or are expanding their selections of treats for pets. A freshly-prepared home-baked treat will be less costly as well as having greater palatability and appeal to pets.

Providing the consumer with frozen or refrigerated commercially packaged uncooked dough as an animal treat can eliminate the need for artificial preservatives found in many pre-baked manufactured treats, as well as giving the consumer the ability to make the treats fresh in their own home. Additionally, by commercially preparing and packaging the treats for purchase by a consumer, the consumer has the opportunity to make as many or as few treats at a given time as well as the ability to determine size and consistency of the treat, leaving more dough available to make treats for their pets at a later time.

Because of the intrinsic nutritional differences between human and pet digestive needs, present doughs and cookies available for human consumption do not offer healthy alternatives for our pets.

The present invention relates to uncooked refrigerated or frozen, commercially packaged pet treat dough. The packaged pet treat dough typically contains a texturizing constituent, a protein constituent, a fiber-based constituent, a fat-based constituent and a moisture-adding material to retain the shape of the dough. The dough is packaged and refrigerated or frozen and then baked at a later time depending on the needs of the consumer. The dough may also be frozen or refrigerated in preformed shapes or may be frozen in a cylindrical form for cutting and shaping prior to placing in the oven. This invention satisfies a previously unmet need for fresh, ready-to-bake pet treats.

### SUMMARY OF THE INVENTION

It is an object of the present invention to provide a novel and improved nutritious pet snack.

It is another object of the present invention to provide for a pet snack that is easy to store in an uncooked state for later baking prior to consumption.

It is a further object of the present invention to provide for a pet snack that is fresh and requires minimal or no preservatives.

It is yet another object of the present invention to provide for a pet snack that is low in cost and convenient to use.

It is a final object of the present invention to provide for a novel and improved method in which a pet snack may be commercially prepared in sufficient quantities to allow for packaging and storing at a reduced temperature.

In accordance with the present invention, there is provided a commercially packaged dough product for pets consisting of a texturizing constituent present in an amount between 10% to 80% of the total weight of the product, a protein-based constituent present in an amount of about 5% to 30% of the total weight of the product, a fat-based constituent present in an amount between about 1% to 25% of the total weight of the product, a fiber-based constituent present in an amount between about 1% to 15% of the total weight of the product and a liquid constituent in an amount sufficient to form a cohesive dough product wherein the product contains no preservatives, is unleavened and is stored and packaged in an uncooked state. There is also provided a method of manufacturing a packaged pet snack product made from the steps of blending constituents together, packaging and storing the blended product at a reduced temperature in preparation for later baking.

The above and other objects, advantages and features of the present invention will become more readily appreciated and understood from a consideration of the following detailed description of preferred and modified forms of the present invention when taken together with the accompanying drawings in which:

### BRIEF DESCRIPTION OF THE DRAWINGS

FIG. 1 is a form of packaging for the dough of the present invention;

FIG. 2 is another form of packaging for the dough of the present invention;

FIG. 3 is an alternate form of packaging for the dough of the present invention;

FIG. 4 is the dough packaging of FIG. 3 in its completed packaged form;

FIG. 5 is another form of packaging of the dough of the present invention; and

FIG. 6 is a schematic drawing of the method of making packaged pet snack dough.

### DETAILED DESCRIPTION OF PREFERRED EMBODIMENTS

The preferred form of the present invention provides a refrigerated or frozen, uncooked snack product which is commercially prepared and packaged for later baking and consumption by pets, especially for domesticated dogs and cats, the primary purpose of which is to be used as a treat for praise or reward to the pet. A guiding principle in formulating this pet snack product is to provide a high level of palatability for pets, especially dogs, and also to provide a product that is primarily of fresh ingredients. The pet treat food product of this invention is made available to the consumer either in a refrigerated or frozen commercially packaged uncooked form. Unlike snacks for human consumption, the present invention does not contain any type of leavening agents, such as, yeast, baking soda or baking powder.

Unlike dog food, the American Association of Feed Control Offices (AAFCO) does not have strict guidelines for the fiber, protein and moisture content for pet treats. Since it is not intended to be a dietary staple, but rather an occasional treat, these values are not as critical.

That being said, the importance of what products are used is really based on five deciding factors: palatability, digestibility, cost, health benefits of specific products and potential for allergic reaction.

Taking these factors, for instance as applied to the type of grain or texturizing constituent used, is discussed as follows:

Palatability is simply a matter of the pet's decision, much the same as a human prefers white or wheat bread. Dogs, for instance, may prefer a rice-based or wheat-based grain texturizing constituent.

Digestibility is also of concern: Dogs' bodies break down, digest and absorb different grains with varying levels of success. For example, a dog's digestive system does not break down corn well, so most veterinarians consider corn a filler, offering little or no nutritional value. Yet another complication in this area is that different species of animals can better digest grains differently. Despite being a carnivore (as opposed to a dog which is an omnivore), cats are actually better able to digest corn than a dog.

Cost is of course a major issue. Any larger treat manufacturers will lean toward using grains like corn to keep their costs down. The “better” grains, such as, barley and oats afford pets more nutritional value but are much more expensive when you look at large-scale production.

Some grains can produce health benefits. Flax seed is a common grain that can improve skin and coat through its naturally occurring oils. Soy, while a potential allergen (see below) can be beneficial for adding protein to a non-meat treat.

The presence of allergens in certain grains is also a concern. Many people are surprised to learn that corn, wheat and soy contain allergens that can produce allergic responses, often in any form from itching to severe gastrointestinal distress. Hence, if a company wishes to produce a “sensitive stomach” type of treat they will avoid these grains.

The primary ingredients of this invention typically include a texturizing constituent, a moisture-based constituent, a fiber-based constituent, a protein-based constituent and a fat-based constituent. A number of products may satisfy both categories, such as, a texturizing constituent may also act as a fiber, and a protein or fat may act as a moisture-based constituent as well. Blending of these ingredients together forms a blended product or dough product which is ready for packaging and storage at a temperature below room temperature. The reference to a dough product indicates the presence of a texturizing constituent, such as, flour which adds shape, bulk and texture to the product. Unless otherwise stated, all percentages and portions are on a total weight basis of the pet snack.

The texturizing constituents which include grain products may take a number of different forms based on the requirements of the particular treat. The texturizing constituents most often used include flour, either processed or unprocessed, derived from wheat, corn, rice, barley, oats, rye or the like. The dough product may also include a mixture of whole grains and processed or unprocessed flour. A substitution for a grain-based product may also include a filler product, such as, starches including root vegetables, potatoes, squash and rice or any other type of material that acts as a medium to allow the pet treats to retain their shape and gives the treat texture. Any type of flour or grain can be used. Typically, the flour and/or grain content of the uncooked dough is normally from about 10% to 80% of the total weight of the dough product and optimally from about 20% to about 70% by weight.

The most common crude protein used would be meat but, as mentioned above, proteins can come from other sources, such as, soy or even possibly whey. Other ingredients, such as, eggs, nuts and peanut butter can “bump” protein percentages in a treat and are typically less costly than meat. In terms of proteins that could not be used, there are none. Protein is a question of quality. For example, a muscle meat or a defined meat, such as, chicken meal, would be superior to a protein, such as, a meat meal (animal not defined) or animal by-products. The animal meats include but are not limited to horse, cow, pig, fowl, lamb as well as fish. Animal byproducts, such as, eggs and whey may also be used. Plant products containing protein including soy, nuts and nut butter may also be used. The dough should have a crude protein content from 5% to about 30% of the total weight of the dough product and optimally from about 8% to 17%.

The fat-based constituent can include those of animal or plant origin, again based on issues, such as, palatability, digestibility, cost, benefits of specific fats and potential for allergic reaction. Some examples of fats would be animal-sourced fats, the majority of which would be solid at room temperature, but could also be animal-derived oils, such as, fish oils which are also rich in omegas, that would be liquid at room temperatures. Another example would be butter, which would be solid but very soft at room temperature. Milks and yogurts, depending on if whole or low-fat, would also contribute to fat content. The dough should have a fat content from about 1% to about 25% of the total weight of the dough product and optimally from about 1% to 19%.

In pet treats, fat is the most susceptible to spoilage. Fat spoilage (oxidation) decreases the nutritional value of the pet treat, makes it less palatable and can even make the pet treat unsafe. Additives may prevent oxidation but most additives provide no nutritional value. Additives may include emulsifiers to prevent water and fat from separating. Preservatives which prevent oxidation can be either artificial or natural. The most common artificial preservatives are ethoxyquin, butylated hydroxytoluene (BHT) and butylated hydroxyanisole (BHA), propyl gallate and propylene glycol. Tocopherols (vitamin E) and absorbic acid (vitamin C) are the most common natural preservatives. Preservatives may or may not be added depending upon the requirements of the particular individual purchasing the pet snacks. Other additives may include artificial colors and flavoring to make the product more attractive to purchasers and more palatable to their companion animals.

A fiber-based constituent is added to the dough which is usually beneficial to the animal. Fibers could come in a hard or soft form. Some fiber sources in the higher quality treats include pumpkin, beet, sweet potato, peas, apples with the skin, whole wheat, potatoes, broccoli, carrots and various nuts. However, in the poorer quality treats, fiber sources like corn can be utilized. Depending on the particular source, the item might be put in whole, squashed, chopped, blended, boiled, cooked, baked or ground. Some of the fibers possibly might not need to be greatly processed in advance, as they will change their state when cooked. The dough should have a crude fiber content from about 1% to about 15% of the total weight of the dough product and optimally about 1% to 6% of the total weight.

The moisture or liquid-based constituent may take a number of different forms. If you look at liquids in the sense of adding moisture to the dried ingredients, these have a large impact on the taste. Some of the liquids used may be peppermint extract, applesauce, milk, yogurt, honey, egg and safflower oil. Various fruits and vegetables can also add moisture, such as, pumpkin or sweet potato. As stated earlier, there may be some cross-over between the elements added to the current invention. For example, adding an egg to the grain-based constituent satisfies the requirement for a protein as well as providing liquid or moisture to the mixture.

Some other common liquids in foods and treats of lesser quality are ingredients, such as, corn syrup and corn gluten meal which bind water molecules to prevent oxidation, unfortunately in a way that may encourage gas and colon problems.

The addition of water or some other type of moisturizing constituent allows the ingredients to form a cohesive shape in the form of a biscuit or shape that can be easily baked at a later time. The moisturizing constituent is very important in the present invention. The amount of moisture will determine the hardness or consistency of the pet snack which is important, especially with dogs and cats. Pet snacks with a very hard consistency may aid in removing tartar and plaque from the animal's teeth. A hard biscuit is not a desirable trait in a human snack as it may cause dental complications. Further, the absence of any type of leavening agent in this invention also aids in producing a pet snack that typically has a harder consistency. A leavening agent would serve no purpose in the formation of a pet treat. Humectants may also be used, such as, propylene glycol which promote retention of moisture in the treat. The additional moisture of humectants may be desirable when producing pet snacks for an older animal that may need softer treats due to dental complications. Artificial emulsifiers also fall within this category and could potentially be used. The dough should have a moisture content of from about 10% to about 80% of the total weight of the dough product, preferably from about 10% to 70%, and optimally from about 14% to 53%.

Another possible ingredient of the pet treat of the present invention is a nutraceutical constituent or mixture of nutraceutical constituents and/or vitamins and minerals. Nutraceutical products, vitamins and minerals, though not a mandatory addition to the uncooked dough can be added by themselves or in combination with another nutraceutical product. Vitamins and minerals can be added to the dough of the pet treat of the invention to address various pet nutritional and dietary needs. The following are examples.

In utilizing the nutraceutical glucosamine sulfate hydrochloride, the preferred range of nutraceutical in the finished baked treat is 2.5% to 3.5% of the total weight of the treat; though possibly higher to address the needs of dogs with special needs in the area of joint maintenance and/or health.

In utilizing the nutraceutical chondroitin sulfate, the preferred range of nutraceutical in the finished treat is 1% to 2% of the total weight of the treat; though possibly higher to address the needs of dogs with special needs in the area of joint maintenance and/or health.

Other ingredients that serve as both nutraceutical and palatability enhancers, such as, peppermint extract, may vary in percentage as dietary needs of the pet and palatability to the pet are addressed in each individual recipe.

In order to manufacture the dough product, there is no specific order of adding constituents or mixing method required. The typical dough processing method in a commercial setting includes mixing all dry ingredients or constituents including the texturizing, protein-based constituent, fat-based constituent and fiber-based constituent together, preferably at a low speed. See FIG. 6. Next, the liquid or moisture-adding constituent is mixed or added to the other ingredients in an amount sufficient to form a cohesive mass. Insufficient moisture will result in a dough mixture that does not stick together and is difficult to manipulate when preparing the dough for shaping or baking. Further ingredients may be added depending upon the type of pet involved as well as the special needs of each pet. Flavorings, nutraceuticals, and additional fiber, additional protein or fat-based ingredients may also be added to the mixture. Once a cohesive, semi-moist dough is formed, the mixture may be packaged in a number of different ways, to be discussed later. Once packaged, the dough is stored at a reduced temperature, i.e., a temperature below room temperature, sufficient to allow for storage and preservation of the dough for a set period of time. Refrigeration temperatures are preferably between 40° C. and 27° C. and freezer storage temperatures are preferably between 30° C. and −30° C. Alternatively, preservatives, natural or artificial, may be added to increase the life of the product. Shelf life will vary greatly depending on whether preservatives are used. My present treats are all natural, and have a refrigerator life of approximately five days to two weeks, and a freezer life of approximately six months to over a year. Artificial preservatives could take the treats to well over a year in the freezer, and multiple weeks in the refrigerator. The frozen or refrigerated product is then sold to a consumer for immediate or eventual baking, depending on the needs of the consumer.

The following are examples of preferred forms of the invention but are not to act as limitations. Wherever noted, temperatures are in degrees Fahrenheit.

### EXAMPLE 1

1.5 cups whole wheat flour (7.65 oz.)

1 cup oatmeal (3.64 oz.)

1.5 cups peanut butter (13.2 oz.)

1 cup milk (7.2 oz.)

¼ cup carob chips (1.4 oz.)

1 tablespoon applesauce (0.7 oz.)

1 egg (1.9 oz.)

1 tablespoon honey (8 oz.)

Dough Form:

Moisture 27.3%

Protein 16.4%

Crude fiber 1.6%

Crude fat 18.9%

### EXAMPLE 2

1.5 cups brown rice flour (7.75 oz.)

1⅓ cup cheddar cheese (4.0 oz.)

1 tablespoon butter (0.5 oz.)

¾ cup milk (5.4 oz.)

¼ cup shredded carrot (1.9 oz.)

Dough Form:

Moisture 44.9%

Protein 9.9%

Crude fiber 1.9%

Crude fat 10.9%

### EXAMPLE 3

2 cups turkey (20.0 oz.)

⅓ cup cheddar cheese (1.0 oz.)

1 tablespoon parsley (0.0 oz.)

2 eggs (3.8 oz.)

2.5 cups rice flour (12.625 oz.)

2 tbsp. safflower oil (1.0 oz)

½ cup milk (3.6 oz)

Dough Form:

Moisture 51.0%

Protein 13.5%

Crude Fiber 1.3%

Crude Fat 7.3%

### EXAMPLE 4

2 cups whole wheat flour (10.2 oz.)

½ cup soy flour (1.7 oz.)

½ c. parmesan cheese (1.9 oz.)

1 egg (2.1 oz.)

1 cup milk (7.2 oz.)

Directions:

Dough Form:

Moisture 4.36% (Note: outside range.)

Protein 13.9%

Crude Fiber 5.8%

Crude Fat 4.3%

### EXAMPLE 5

2 teaspoons peppermint (0.4 oz.)

1.5 cup oatmeal (5.46 oz.)

1.5 cup rye flour (6.9 oz.)

3 tablespoons applesauce (2.1 oz.)

1 tablespoon butter (0.5 oz.)

½ cup milk (3.6 oz.)

2 teaspoons parsley (0.0 oz.)

Dough Form:

Moisture 37.4%

Protein 8.5%

Crude Fiber 1.1%

Crude Fat 3.8%

### EXAMPLE 6

1 cup chopped Fiji apple (3.7 oz.)

1 teaspoon honey (0.2 oz.)

1 egg (1.9 oz.)

½ teaspoon cinnamon (0.05 oz.)

1.5 cup wheat flour (7.65 oz.)

1¼ cups oats (4.55 oz.)

1 cup milk (7.2 oz.)

Dough Form:

Moisture 52.6%

Protein 8.2%

Crude Fiber 1.2%

Crude Fat 1.8%

### EXAMPLE 7

1 cup oatmeal (0.64 oz.)

1 cup wheat (0.1 oz.)

¼ cup peanut butter (2.2 oz.)

¼ cup banana (1.25 oz.)

½ cup plain fat free (4.3 oz.)

¼ cup milk (1.8 oz.)

1 teaspoon honey (0.2 oz.)

Dough Form:

Moisture 39.5%

Protein 10.8%

Crude Fiber 1.3%

Crude Fat 6.4%

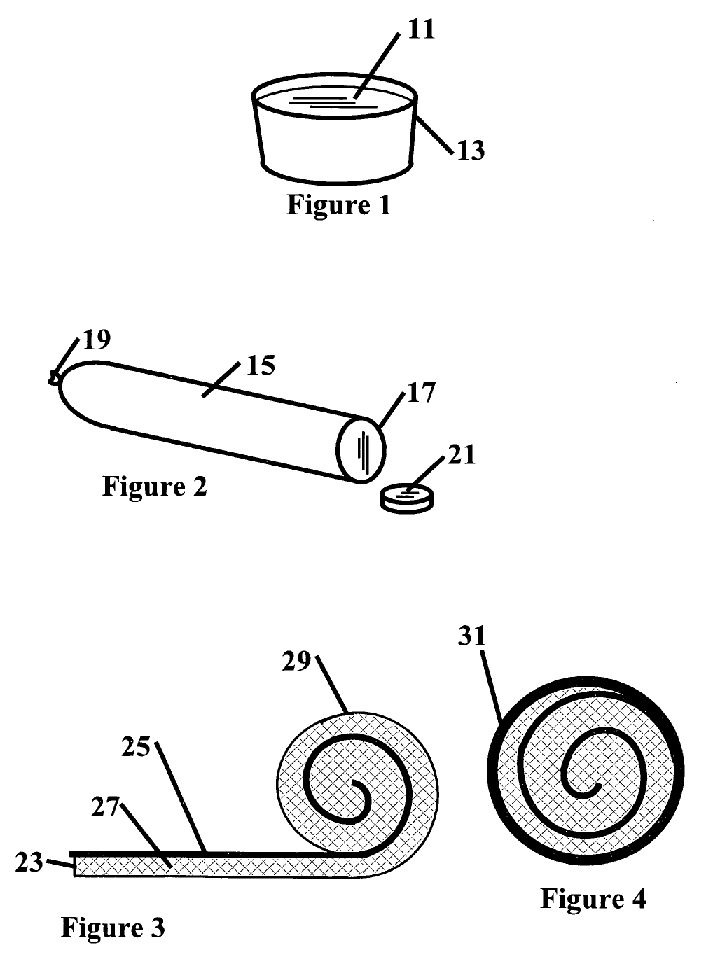

In each Example, all constituents are blended together completely in a container or bowl to form a blended product 11. The blended product may then be placed in a tub or container 13 as shown in FIG. 1 and commercially sold. When the product is desired to be used, it can be removed from the freezer or refrigerator and thawed to room temperature if appropriate and formed into discreet patties for baking. The patties may be placed on a greased or ungreased cookie sheet and placed in the oven at a recommended temperature for a recommended number of minutes to a desired doneness. Alternatively, the dough product may be formed into discreet shapes prior to freezing or refrigerating and then simply packaged and placed in the freezer or refrigerator, and removed for baking when desired.

Another form of packaging involves transferring the blended product to a working surface for packaging. As shown in FIG. 2, the blended product may be formed into a tubular form or cylinder 15. A thin film of plastic 17 is placed or wrapped around the cylinder and each end 19 of the cylinder is heat-sealed or secured in some fashion. The commercial packaging of this product aids in preserving the product, makes it easier to ship to stores and allows the consumer to bake a desired quantity. For example, the wrapped cylinder 15 containing the blended product is placed in a refrigerator or freezer for later baking. When desired, the cylinder may be removed from the freezer or refrigerator, all or a portion of the film 17 may be removed, and the blended product may be sliced in preparation for baking. A sliced product 21 is placed onto an ungreased cookie sheet and baked. For a firmer, flatter snack, the product may be pressed with a fork or other utensil or rolled out onto a lightly floured surface and cut into shapes. The blended product is baked at 200° F. to 375° F. and preferably baked at 300° F. for 45-50 minutes. At higher altitudes, the baking temperature should be increased to 315° F.

Baking time will vary from oven to oven but a broad range of baking time is approximately five minutes to ninety minutes. A range for thickness of the dough product would be ¼″ to ¾″. Greasing the cookie sheet would also be possibility of course, though not a preferred method.

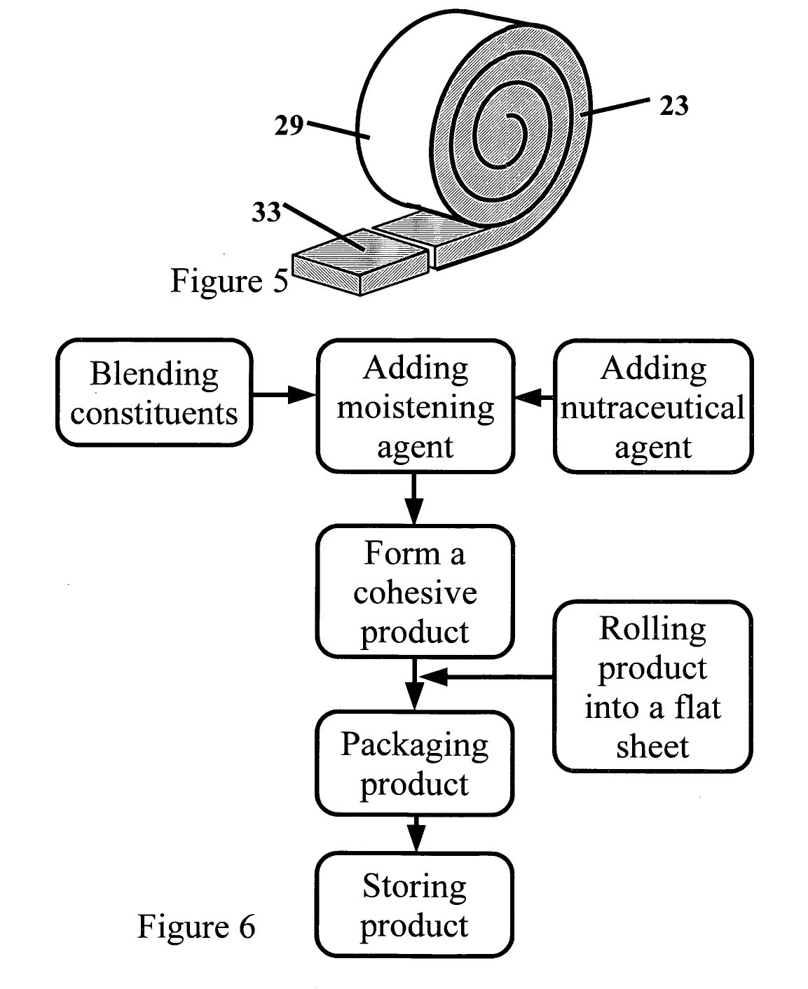

Another alternate method of commercial packaging prior to sale to a consumer and refrigeration or freezing, includes rolling the dough 11 into a flat sheet 23 approximately ¼ to a 1″ thickness, depending upon the desired thickness of the pet treat. This is shown in FIGS. 3 and 4. A low adhesion film 25 may be placed on an upper surface 27 of the dough sheet. The dough sheet 23 along with the low adhesion film 25 may be rolled into a narrow coil or cylindrical form 29 and packaged with a thin outer packaging film 31 as shown in FIG. 4. The ends would be sealed as previously described in FIG. 2 and the dough product may then be stored either in a freezer or a refrigerator for later baking. At the time of baking, the outer packaging 31 may be cut open and the cylindrical form 29 may be unrolled into its original flat sheet form. The low adhesion film 25 may be removed and, if desired, the dough product may be thawed and cut into shapes or formed into small balls. The shapes or balls may be placed on a greased or ungreased cookie sheet and placed in an oven at a recommended temperature for a recommended number of minutes, depending upon the doneness required. Further, if so desired, the cylindrical roll may be only partially unrolled to expose a portion of the dough sheet 33 as shown in FIG. 5. If only a few pet treats are desired to be baked, the rest of the sheet 23 may be placed back in the packaging and put back into the freezer or refrigerator for later use. In each method, the product is commercially prepared and packaged for purchase by a consumer.

It is therefore to be understood that while preferred forms of invention are herein set forth and described, the above and other modifications may be made therein without departing from the spirit and scope of the invention as defined by the appended claims and reasonable equivalents thereof.

I claim:

1. A commercially packaged dough product for pets consisting of:
a texturizing constituent present in an amount between about 10% to 80% of the total weight of said product;
a protein-based constituent present in an amount between about 5% to 30% of the total weight of said product;
a fat-based constituent present in an amount between about 1% to 25% of the total weight of said product;
a fiber-based constituent present in an amount between about 1% to 15% of the total weight of said product; and
a liquid constituent in an amount sufficient to form a cohesive dough product wherein said product contains no preservatives, is unleavened and is packaged and stored in an uncooked state.

2. The product according to claim 1 wherein said texturizing constituent is present in an amount optimally between about 20% to 70% of the total weight of said product.

3. The product according to claim 1 wherein said protein constituent is present in an amount optimally between about 8% to 17% of the total weight of said product.

4. The product according to claim 1 wherein said fat constituent is added in an amount optimally between about 1% to 19% of the total weight of said product.

5. The product according to claim 1 wherein said fiber constituent is added in an amount optimally between about 1% to 6% of the total weight of said product.

6. The product according to claim 1 wherein said texturizing constituent is selected from the group consisting of processed and unprocessed grain-based flour, grains, root vegetables, squash and potatoes.

7. The product according to claim 1 wherein said protein-based constituent is selected from the group consisting of animal meat, animal byproducts, soy and nuts.

8. The product according to claim 1 wherein said fat-based constituent is selected from the group consisting of animal and plant derived oils and dairy products.

9. The product according to claim 1 wherein said fiber-based constituent is selected from the group consisting of fruits and vegetables, nuts and grains.

10. The product according to claim 1 wherein said liquid is added in an amount optimally between about 14% to 53% of the total weight of said product.

11. A commercially packaged, uncooked pet snack product, said snack product made from the steps of:
blending together a fiber-based constituent, a fat-based constituent, a protein-based constituent and a texturizing constituent;
adding a moistening agent to sufficiently form a blended, cohesive product;
packaging said blended product for storage; and
storing said packaged product at a reduced temperature until ready for baking.

12. The product according to claim 11 wherein said steps further include adding a nutraceutical constituent prior to adding a moistening agent.

13. The product according to the process of claim 11 wherein said blended product is rolled into a flat sheet prior to packaging.

14. The product according to the process of claim 13 wherein said flat sheet is rolled into a cylindrical shape.

15. The product according to the process of claim 13 wherein said flat sheet may be cut into discrete shapes.

16. The product according to the process of claim 13 wherein a low adhesion film is placed on a surface of said flat sheet, said sheet and said film being rolled into a narrow coil.

17. A method of commercially preparing uncooked, packaged pet snack products, comprising the steps of:
mixing appropriate amounts of texturizer, protein, fat and fiber together and wherein said texturizer is present in an amount between about 20% to 70% of the total weight of said product, said protein is present in an amount between about 8% to 17% of the total weight of said product, said fat is present in an amount between about 1% to 19% of the total weight of said product, and said fiber is present in an amount between about 1% to 6% of the total weight of said product;
adding a liquid in an amount between about 14% and 53% of the total weight of said product;
blending said texturizer, protein, fat and fiber with said liquid to form a cohesive product;
packaging said product in a container; and
storing said product at a reduced temperature prior to baking.

18. A method according to claim 17 wherein said steps include adding a nutraceutical constituent prior to packaging.

19. A method according to claim 17 wherein said steps include adding a flavoring prior to packaging.

20. A method according to claim 17 wherein said steps include rolling said product into a flat sheet and placing a low adhesion film on an upper surface of said sheet prior to packaging.

21. A method according to claim 20 wherein said steps further include forming said sheet into a tubular form or coil.

22. A method according to claim 17 wherein said steps further include forming said product into discrete shapes prior to said packaging.
